(19) United States
(12) Patent Application Publication
(10) Pub. No.: US 2026/0270963 A1
(43) Pub. Date: Sep. 10, 2026

(54) ENHANCING DOWNLINK CAPACITY IN UPLINK-HEAVY FR2 TRANSMISSIONS

(71) Applicant: T-Mobile USA, Inc., Bellevue, WA (US)

(72) Inventor: Mochamad Mirza, Bothell, WA (US)

(21) Appl. No.: 19/073,016

(22) Filed: Mar. 7, 2025

(51) Int. Cl. H04W 72/0446; H04L 5/14; H04W 72/0453; H04W 72/231

(52) U.S. Cl. CPC H04W 72/0446; H04L 5/14; H04W 72/0453; H04W 72/231

(57) ABSTRACT

Systems and methods for enhancing downlink capacity in uplink-heavy 5G Frequency Range 2 (FR2) transmissions within wireless communication systems are disclosed. When a wireless device requires more uplink capacity, Time Division Duplex (TDD) communications are configured to include more uplink symbols per time slot to enhance uplink throughput. Frequency carriers are aggregated such that one portion contains aggregated carriers that are configured with an uplink-heavy time slot format and a contiguous second portion contains aggregated carriers that are configured with a second time slot format that has fewer uplink symbols. A rule is applied to designate a blank carrier at the boundary between these portions, where no data is transmitted, thereby preventing interference between uplink and downlink symbols occurring at the same time. This configuration increases uplink capacity while mitigating the degradation of downlink throughput compared to configurations in which all carriers share the same time slot format.

### BACKGROUND

Wireless communication systems utilize radio frequency (RF) signals to transmit data between devices. These systems operate across various frequency bands, including sub-6 GHz and millimeter wave (mmW) frequencies. Dedicated frequencies within a frequency band (e.g., channels) can be aggregated and used simultaneously by devices in order to increase bandwidth and throughput. Frequency Division Duplex (FDD) is a duplexing method used in wireless communications where uplink and downlink transmissions are performed by the same device on different carriers. Time Division Duplex (TDD) is a duplexing method where uplink and downlink transmissions share the same frequency band but are separated in time. TDD is often used in Frequency Range 2 (FR2) communications, where uplink and downlink transmissions on neighboring channels can cause interference between the channels.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a flowchart that illustrates a communication flow between a base station and a wireless device during network setup and configuration.

FIGS. 4A and 4B depict tables that illustrate the time slot formats and numbering shown in Table 11.1.1-1 as defined in 3GPP TS 38.213 V15.3.0.

FIGS. 5A and 5B illustrate frame structure configurations in accordance with embodiments of the present disclosure.

FIG. 6 illustrates a process for establishing a downlink-enhanced uplink-heavy FR2 connection.

FIG. 7 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In 5G telecommunications, transmissions can occur in Frequency Range 2 (FR2), also known as millimeter wave (mmW) frequencies, including frequencies between 24.250 GHz and 52.600 GHz. FR2 transmissions can be separated in the frequency domain into carriers, and separated in the time domain into time slots. Time slots can be further divided into symbols, and can have a defined time slot format indicating a pattern of uplink, downlink, and flexible symbols for the duration of the time slot (e.g., time slot formats defined by 3GPP standards). Contiguous carriers can be aggregated and used by a single wireless device in order to increase bandwidth and capacity for the device. Aggregated FR2 carriers often have the same time slot format in order to prevent interference between uplink and downlink transmissions in neighboring carriers.

In situations where transmissions are expected to require more uplink than downlink transmissions, the carriers can be configured to have a time slot format containing more uplink symbols. However, this can lead to an unnecessary degradation in downlink quality. For example, if the time slot format chosen for the carriers specifies more uplink symbols than are needed for uplink transmissions, then symbols that could have been used for downlink transmissions are instead left unused.

The disclosed technology relates to enhancing downlink capacity in uplink-heavy time division duplexed (TDD) wireless communications. Using the disclosed techniques, specific time slot formats can be defined to schedule downlink symbols in one or more carriers after providing sufficient bandwidth for uplink transmissions. Additionally, a rule can be implemented in which no transmissions are expected to be sent or received in a carrier that is between carriers of different time slot formats, in order to prevent interference between carriers performing uplink transmissions and carriers performing downlink transmissions at a given time.

In some implementations, a portion of aggregated carriers are configured with an uplink-heavy time slot format (e.g., a time slot format with more than half of the symbols being uplink symbols) and a second portion of the aggregated carriers (e.g., at frequencies lower than the first portion) are configured with a different time slot format, such as a downlink-heavy format. A rule is implemented in which one or more carriers (e.g., a carrier of the second portion which is neighboring a carrier of the first portion) is designated as a “blank” carrier, and no data is transmitted in this carrier. This gives a buffer in frequency that can prevent interference between uplink symbols of the first portion of carriers and downlink symbols of the second portion of carriers occurring during the same time slot.

In one example aspect, a method is implemented by a user equipment (UE) configured to operate in a set of multiple carriers in FR2. The UE receives a radio resource control (RRC) message from a base station. This message contains configuration information that specifies at least two different slot formats. The first slot format is designed for uplink transmissions and includes more than 7 uplink symbols out of a total of 14 symbols. This format is applied to a subset of carriers designated for uplink transmissions. The second slot format, intended for downlink transmissions, contains no uplink symbols. The UE then performs uplink and downlink transmissions based on this configuration information, following a specific rule. This rule stipulates that no data should be transmitted in the carriers immediately adjacent to the group of carriers used for uplink transmissions, creating a buffer to prevent interference.

In another example aspect, a base station transmits an RRC message to a UE, configuring it to operate across multiple carriers. The message includes information about at least two slot formats, each containing a total of K symbols. A first format, designated for uplink transmissions, has at least K/2 uplink symbols per time slot and is applied to a specific number of carriers for uplink use. A second format, containing no uplink symbols per time slot, is used for a second number of carriers. The base station then receives uplink transmissions from the UE on the designated uplink carriers while simultaneously transmitting downlink data on the other carriers. This configuration allows for efficient use of the available spectrum, increasing the overall capacity of the system.

In another example aspect, a non-transitory, computer-readable storage medium contains instructions that, when executed, enable a system to implement the inter-carrier full duplex technique. The system transmits a message (such as an RRC message) from a base station to a UE, configuring the UE to operate across multiple carriers. The message includes information about two slot formats and a specific rule for transmission. The first slot format, used for uplink transmissions, contains at least half of its total symbols as uplink symbols. The second format, used for downlink transmissions, contains no uplink symbols. The rule specifies that no data should be transmitted in a carrier adjacent to those used for uplink transmissions. This configuration allows the system to perform simultaneous uplink and downlink transmissions on different carriers, effectively increasing the uplink throughput while maintaining system stability by preventing inter-carrier interference.

In yet another example aspect, a system transmits an RRC message from a base station to a UE, configuring the UE to operate across multiple carriers in a first configuration. The RRC message can include information about a first slot format used for uplink transmissions, where at least half of its total symbols are uplink symbols; a second slot format used for downlink transmissions, that contains no uplink symbols; and/or a first rule that specifies no data should be transmitted in one or more carriers adjacent to the boundary between carriers using the first slot format and carriers using the second slot format. The RRC message can alternatively specify a single slot format to be used on all aggregated carriers. The base station and mobile device can exchange transmissions according to the first configuration. The system can then transmit a second message (such as an RRC, MAC, or DCI message), configuring the UE to operate across multiple carriers in a second configuration. The second message can include information about a third slot format used for uplink transmissions, where at least half of its total symbols are uplink symbols, and which can be the first slot format; a fourth slot format used for downlink transmissions, that contains no uplink symbols, and which can be the second slot format; and/or a second rule that specifies no data should be transmitted in one or more carriers adjacent to the boundary between carriers using the first slot format and carriers using the second slot format, which can be the first rule. The second message can alternatively specify a single slot format to be used on all aggregated carriers. The base station and mobile device can exchange transmissions according to the second configuration.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

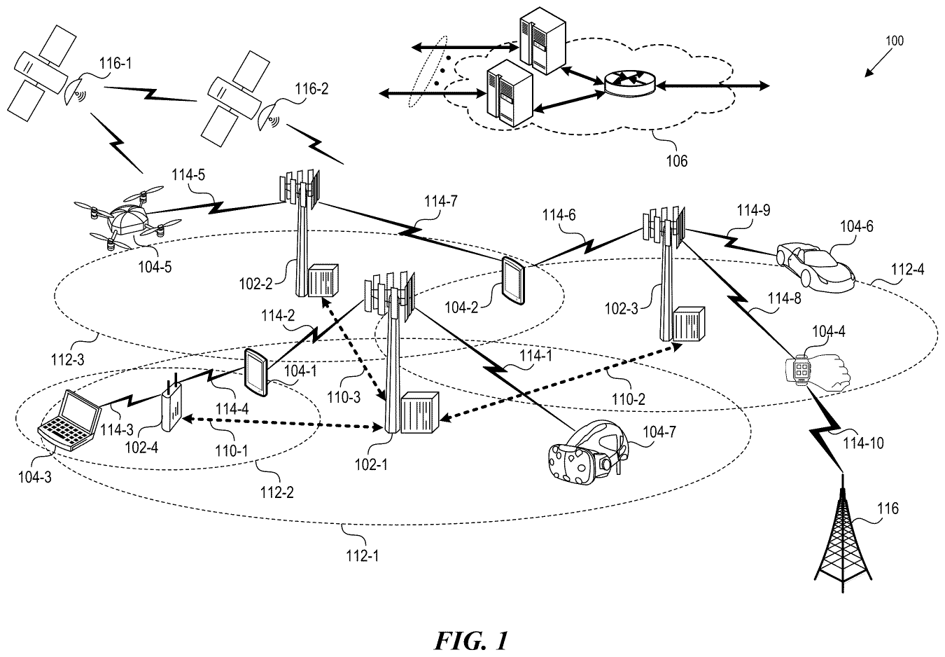

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

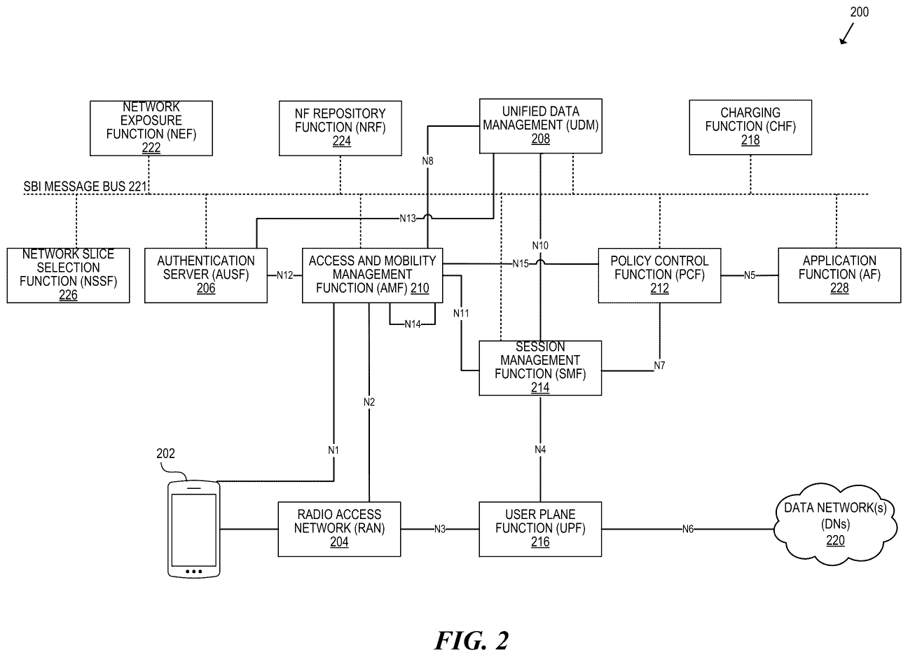

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Enhancing DL Throughput in UL-Heavy Transmissions

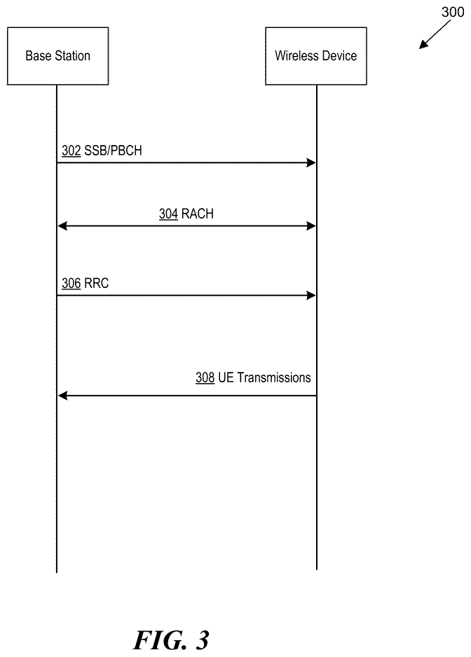

FIG. 3 is a flowchart 300 that illustrates a communication flow between a base station and a wireless device (e.g., base station 102 and wireless device 104 as described with respect to FIG. 1) during network setup and configuration.

At 302, the base station can transmit a synchronization signal to the wireless device. This synchronization signal can be a Synchronization Signal Block/Physical Broadcast Channel (SSB/PBCH) signal, which allows the wireless device to synchronize with the network and obtain initial system information.

At 304, the wireless device can initiate a Random Access Channel (RACH) procedure. This can involve the wireless device sending a random access message to the base station. The RACH procedure is used to establish initial communication between the wireless device and the base station.

At 306, the base station can send a radio resource control (RRC) connection request message to the wireless device. This RRC message can contain configuration information for the wireless device, including details about allowed frequency channels and their usage configuration. The configuration information in the RRC message can specify slot formats to be used for various allocated carriers (e.g., frequency bands). Additionally, or alternately, the RRC message can specify rules for what data is expected in certain carriers and/or at certain times. The RRC message can instruct the wireless device to operate in a set of carriers.

At 308, the wireless device can begin transmitting communications to the base station. These transmissions can include both uplink and downlink communications. The wireless device can perform these uplink and downlink transmissions based on the configuration information received in the RRC message, and according to any rules specified in the configuration.

A communication configuration can include a specified usage of times and frequencies known as a frame structure. For example, a range of frequencies (e.g., FR2) can be divided into channels, each with a frequency range (e.g., bandwidth) and supporting transmission of data. Similarly, transmissions can be divided in the time domain. For example, transmissions can be separated into radio frames (e.g., of 10 ms in length), which can be further divided into subframes (e.g., of 1 ms in length), which can be further divided into slots (e.g., 1, 2, 4, or 8 slots per subframe), which can be further divided into symbols (e.g., 7, 12, or 14 symbols per slot).

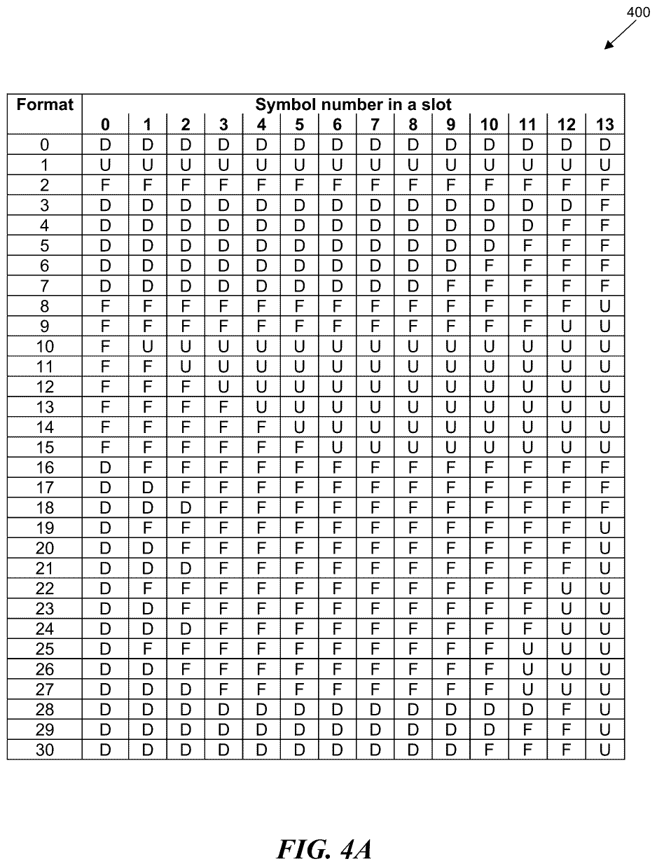

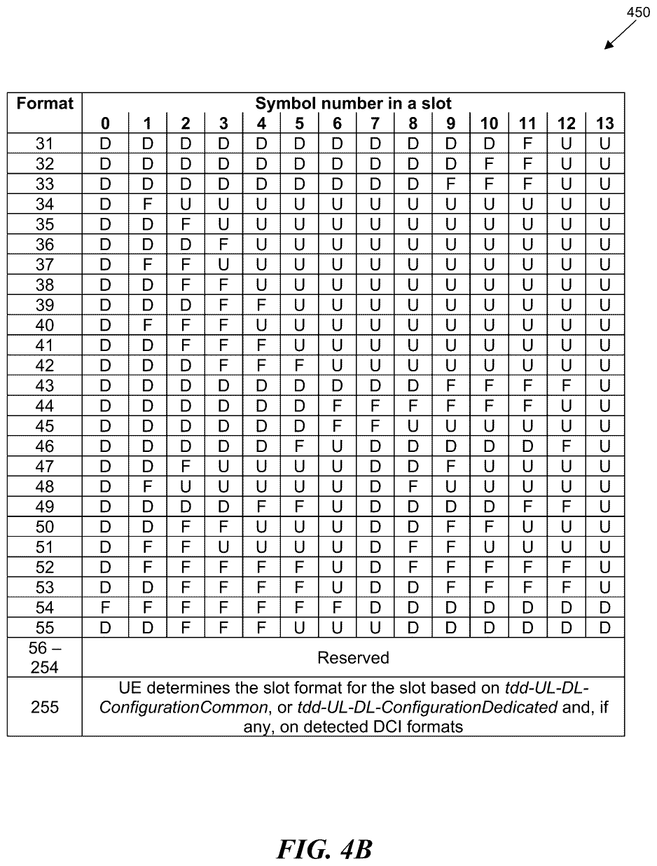

FIGS. 4A and 4B depict tables 400 and 450 that illustrate the time slot formats and numbering shown in Table 11.1.1-1 as defined in 3GPP TS 38.213 (V15.3.0). A time slot format specifies the usage of each symbol in a slot The usage of a symbol can correspond to uplink (U) or downlink (D) communications and can additionally include flexible symbols (F) that are not specified by the time slot format and can be dynamically changed to uplink or downlink in each slot. The usage of symbols can repeat (e.g., are cyclical) for each slot in a frame or subframe.

After an initial RRC setup, a frame structure can be communicated to a wireless device, e.g., through subsequent RRC messages, Medium Access Control (MAC) layer signaling, and/or Downlink Control Information (DCI) messages. This allows the base station to adapt the frame structure in real-time based on current network conditions, traffic demands, and interference levels. For instance, the base station can send updated configuration information specifying new time slot formats, carrier aggregation settings, and/or transmission rules. The base station and the wireless device can then transmit data according to the new configuration data and/or new frame structure.

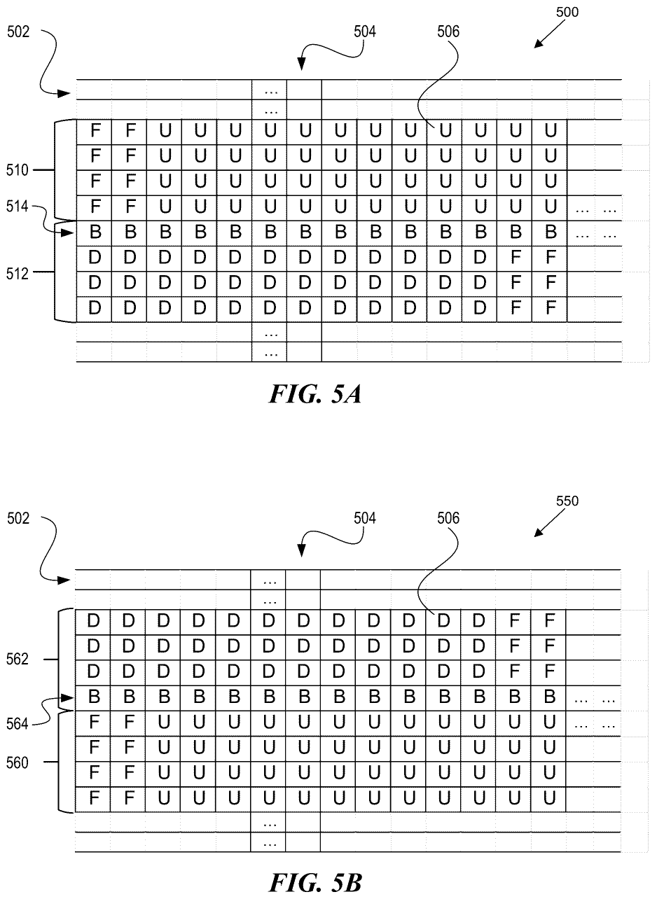

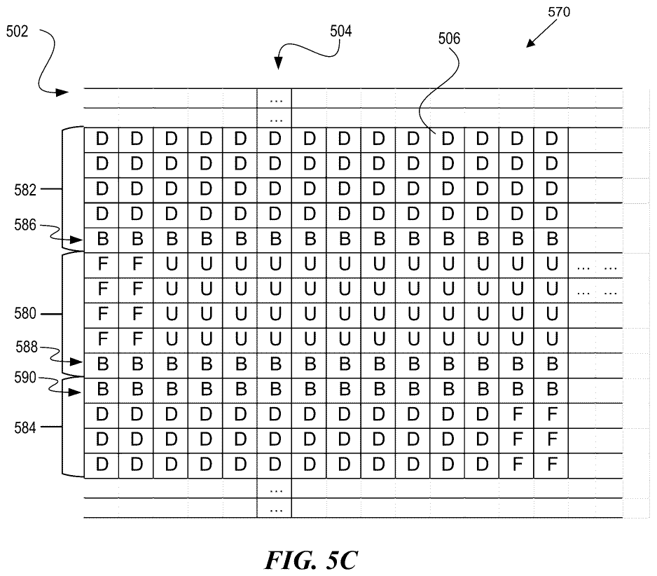

FIGS. 5A, 5B, and 5C illustrate frame structure configurations in accordance with embodiments of the present disclosure. The frame structure configurations include configurations for a number of channels 502 in the frequency domain and a number of time slots 504 in the time domain. Channels with higher frequencies are illustrated above channels with lower frequencies, and time slots at later times are illustrated to the right of time slots at earlier times. Each combination of one channel 502 and one time slot 504 is associated with a symbol 506.

FIG. 5A illustrates a frame structure configuration 500 that can be used in telecommunications between two devices (e.g., a base station and a mobile device). Frame structure configuration 500 can generally be applied to telecommunications of any slot, subframe, and/or frame configuration (for example, 14 symbols per slot, as illustrated in FIG. 5A). The frame structure configuration 500 utilizes carrier aggregation (a total of 8 carriers are illustrated in FIG. 5A), which is divided into an uplink carrier group 510 and a downlink carrier group 512. The uplink carrier group 510 can contain any number of carriers, and can contain a majority of uplink symbols (for example, 12 uplink symbols in a total of 14 symbols, as illustrated in FIG. 5A, corresponding to Format 11 of FIG. 4A). The downlink carrier group 512 can contain any number of carriers, and can no uplink symbols and/or a minority of uplink symbols (for example, 12 downlink symbols, as illustrated in FIG. 5A, corresponding to Format 4 of FIG. 4A). The uplink carrier group 510 in frame structure configuration 500 is configured to include frequencies immediately adjacent to and higher than the downlink carrier group 512.

The frame structure configuration 500 can additionally be configured with a rule to include one or more blank carriers 514, configured to contain blank (B) symbols in which no data is transmitted, in order to prevent interference between carriers of the uplink carrier group 510 and the downlink carrier group 512. For example, a device using the frame structure configuration 500 (e.g., a base station) can be configured with a rule to transmit no data on the blank carrier 514. Thus, the frame structure configuration 500 can specify that the blank carrier 514 is a carrier of the downlink carrier group 512 and is configured to contain zero and/or a minority of uplink symbols (e.g., is in the same time slot format as the other channels in downlink carrier group 512) while no data is transmitted on the blank carrier 514 due to the rule (e.g., the symbols can be treated as blank symbols). Alternately, or additionally, the blank carrier 514 can be a carrier of the uplink carrier group 512 and be configured to contain a majority of uplink symbols, but have no data transmitted due to the rule.

In some implementations, the uplink carrier group 510 is configured with a time slot format in which more than half of the specified symbols are uplink symbols (e.g., more than 7 symbols of a total of 14 symbols). The slot format of the uplink carrier group 510 can conform to a predetermined specification, such as a 3GPP specification (e.g., Table 11.1.1-1 in 3GPP TS 38.213, as illustrated in FIGS. 4A and 4B). In some implementations, the downlink carrier group 512 is configured with a time slot format in which more than half of the specified symbols are downlink symbols (e.g., more than 7 symbols of a total of 14 symbols). In some implementations, one or more blank carriers 514 are configured with a time slot format of the uplink carrier group 510, the downlink carrier group 512, or a different time slot format (e.g., any format of Table 11.1.1-1, as illustrated in FIGS. 4A and 4B). In some implementations, one or more blank carriers 514 are carriers of the downlink carrier group 512 and/or one or more blank carriers 514 are carriers of the uplink carrier group 510.

FIG. 5B illustrates a frame structure configuration 550 that can be used in telecommunications between two devices (e.g., a base station and a mobile device). Frame structure configuration 550 can generally be applied to telecommunications of any slot, subframe, and/or frame configuration (for example, 14 symbols per slot, as illustrated in FIG. 5B). The frame structure configuration 550 utilizes carrier aggregation (a total of 8 carriers are illustrated in FIG. 5B), which is divided into an uplink carrier group 560 and a downlink carrier group 562. The uplink carrier group 560 can contain any number of carriers, and can contain a majority of uplink symbols (for example, 12 uplink symbols in a total of 14 symbols, as illustrated in FIG. 5B, corresponding to Format 11 of FIG. 4A). The downlink carrier group 562 can contain any number of carriers, and can no uplink symbols and/or a minority of uplink symbols (for example, 12 downlink symbols, as illustrated in FIG. 5B, corresponding to Format 4 of FIG. 4A). The uplink carrier group 560 in frame structure configuration 550 is configured to include frequencies immediately adjacent to and lower than the downlink carrier group 562. In some implementations, the uplink carrier group 560 is configured with a time slot format in which more than half of the specified symbols are uplink symbols (e.g., more than 7 symbols of a total of 14 symbols). In some implementations, the downlink carrier group 562 is configured with a time slot format in which more than half of the specified symbols are downlink symbols (e.g., more than 7 symbols of a total of 14 symbols).

The frame structure configuration 550 can additionally be configured with a rule to include one or more blank carriers 564, configured (e.g., by the frame structure configuration 550 and/or by an additional rule) to contain blank (B) symbols in which no data is transmitted, in order to prevent interference between carriers of the uplink carrier group 560 and the downlink carrier group 562. In some implementations, one or more blank carriers 564 are carriers of the downlink carrier group 562 and/or one or more blank carriers 564 are carriers of the uplink carrier group 560.

In some implementations, there can be multiple uplink carrier groups (e.g. 510, 560) and/or multiple downlink carrier groups (e.g., 512, 562). For example, a single uplink carrier group can have a first downlink carrier immediately adjacent to and at a higher frequency than any carrier in the uplink carrier group, and can have a second downlink carrier immediately adjacent to and at a lower frequency than any carrier in the uplink carrier group. Similarly, a downlink carrier group can have a first and a second uplink carrier group immediately adjacent to and at a higher and lower frequency, respectively, than the downlink carrier group. Multiple uplink and downlink carrier groups can alternate in a frequency domain. Each neighboring pair of carrier groups (e.g., each immediately adjacent uplink/downlink carrier group pair) can have one or more blank carriers (e.g., 514, 564) configured at the boundary between the carrier groups. The one or more blank carriers can be carriers of the uplink carrier group and/or carriers of the downlink carrier group.

FIG. 5C illustrates a frame structure configuration 570 that can be used in telecommunications between two devices (e.g., a base station and a mobile device). Frame structure configuration 570 can generally be applied to telecommunications of any slot, subframe, and/or frame configuration (for example, 14 symbols per slot, as illustrated in FIG. 5C). The frame structure configuration 570 utilizes carrier aggregation (a total of 14 carriers are illustrated in FIG. 5C), which is divided into an uplink carrier group 580 and two downlink carrier groups 582, 584. The uplink carrier group 580 can contain any number of carriers (five shown in FIG. 5C), and can contain a majority of uplink symbols (for example, 12 uplink symbols in a total of 14 symbols, as illustrated in FIG. 5C, corresponding to Format 11 of FIG. 4A). The downlink carrier groups 582, 584 can contain any number of carriers (e.g., 4 or 5, as shown in FIG. 5C), and can no uplink symbols and/or a minority of uplink symbols (for example, 14 downlink symbols per 14 symbols, as illustrated in FIG. 5C for downlink carrier group 582, corresponding to Format 0 of FIG. 4A; or 12 downlink symbols per 14 symbols, as illustrated in FIG. 5C for downlink carrier group 584, corresponding to Format 4 of FIG. 4A). The uplink carrier group 580 in frame structure configuration 570 is configured to include frequencies immediately adjacent to and lower than the downlink carrier group 582 and immediately adjacent to and higher than the downlink carrier group 584. In some implementations, the uplink carrier group 570 is configured with a time slot format in which more than half of the specified symbols are uplink symbols (e.g., more than 7 symbols of a total of 14 symbols). In some implementations, the downlink carrier groups 582, 584 is configured with a time slot format in which more than half of the specified symbols are downlink symbols (e.g., more than 7 symbols of a total of 14 symbols).

The frame structure configuration 570 can additionally be configured with a rule to include one or more blank carriers 586, 588, 590, configured (e.g., by the frame structure configuration 570 and/or by an additional rule) to contain blank (B) symbols in which no data is transmitted, in order to prevent interference between carriers of the uplink carrier group 580 and the downlink carrier groups 582, 584. In some implementations, one or more blank carriers (e.g., blank carriers 586, 590) are carriers of the downlink carrier groups 582, 584 and/or one or more blank carriers (e.g., blank carrier 588) are carriers of the uplink carrier group 580.

### Process Flow

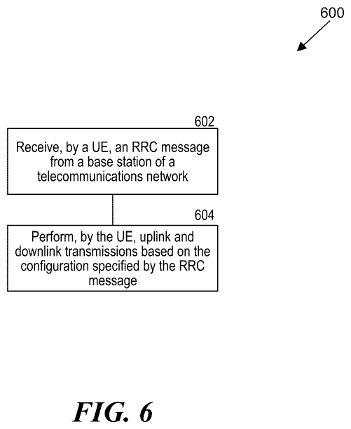

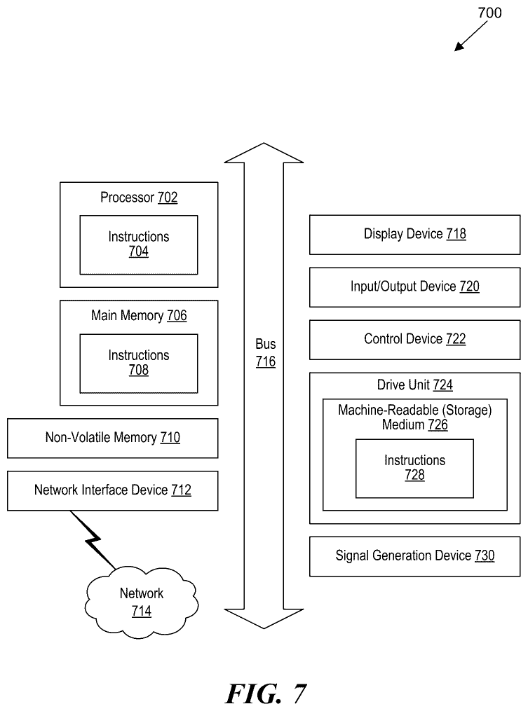

FIG. 6 illustrates a process 600 for establishing a downlink-enhanced uplink-heavy FR2 connection. The process 600 can be implemented using computing devices, such as a base station, a UE, and/or the computer system 700 as described with respect to FIG. 7.

At 602, a UE can receive an RRC message from a base station. The UE can be configured to utilize carrier aggregation for multiple carriers in a frequency range. For example, the UE can be configured to operate on a set of M carriers (e.g., on carriers in FR2 from 24.25 GHz to 71.0 GHz) and support carrier aggregation of N carriers, where N is smaller than M. In some implementations, N is greater than or equal to twice the value of N. In some implementations, M is equal to one of 4, 8, or 12. In some implementations, N is equal to one of 4, 7, 8, or 12.

The RRC message can include information indicating at least two slot formats. A first slot format can be applicable for uplink transmissions. In some implementations, the first slot format can indicate a number of slots per subframe, where more than half of the slots are uplink symbols. For example, the first slot format can indicate more than 7 uplink symbols in a total of 14 symbols. Examples include Formats 1 and 10-15 as defined in Table 11.1.1-1 of the 3GPP Technical Specification 38.213 and as shown in FIG. 4A. For example, the first slot format can be one of: UUUUUUUUUUUUUU (Format 1 of FIG. 4A), FUUUUUUUUUUUUU (Format 10 of FIG. 4A), or FFUUUUUUUUUUUU (Format 11 of FIG. 4A), where U represents an uplink symbol and F represents a flexible symbol. In some implementations, the first slot format can include zero downlink symbols. In some implementations, the first slot format can comprise a total of K symbols, with at least K/2 uplink symbols. For example, K can be either 12 or 14.

A second slot format can be applicable for downlink transmissions. In some implementations, the second slot format can indicate a number of slots per subframe, where more than half of the slots are downlink symbols. For example, the second slot format can indicate more than 7 downlink symbols in a total of 14 symbols. Examples include Formats 0 and 3-7 as defined in Table 11.1.1-1 in the 3GPP Technical Specification 38.213 and as shown in FIG. 4A. For example, the second slot format can be one of: DDDDDDDDDDDDDD (Format 0 of FIG. 4A), DDDDDDDDDDDDDF (Format 3 of FIG. 4A), or DDDDDDDDDDDDFF (Format 4 of FIG. 4A), where D represents a downlink symbol and F represents a flexible symbol. In some implementations, the second slot format can include zero uplink symbols. In some implementations, the second slot format can be applicable for (M-N) carriers for downlink transmissions.

At 604, the UE can perform uplink and downlink transmissions based on the configuration information specified in the RRC message. The UE can additionally perform transmissions based on a rule which specifies that no data is expected to be transmitted (e.g., sent or received) in a carrier before or after (e.g., a neighboring carrier of a lower or higher frequency, respectively) the aggregated carriers that are configured for uplink transmissions. The rule can be specified in the RRC message or at an earlier or later time. The rule can be stored in the one or more communicating devices and used in response to sending or receiving the configuration information specified in the RRC message. In some implementations, the UE is configured to support a carrier aggregation of N carriers for uplink transmissions, and the rule specifies that no data is expected to be transmitted in a carrier before or after the N carriers for uplink transmissions.

In some implementations, the configuration information further indicates that the second slot format is applicable for a number of contiguous carriers before or after the N carriers for uplink transmissions, and the rule specifies that no data is expected to be transmitted in a carrier conforming to the second slot format. In some implementations, a number of carriers in the first and second slot formats are placed in alternating blocks in the frequency domain. In one example, the UE can be configured to support carrier aggregation of P carriers for downlink transmissions to the base station, where the sum of N and P is not greater than M. Furthermore, the configuration information can indicate that the second slot format is applicable for P carriers for downlink transmissions. The P carriers can be before or after the N carriers for uplink transmissions, and the rule can specify that no data is expected to be sent or received in a carrier of the P carriers for downlink transmissions. In another example, the second slot format can be applicable for P contiguous carriers before the N carriers for uplink transmissions and for Q contiguous carriers after the N carriers for uplink transmissions, where the sum of P, N, and Q is less than or equal to M. Furthermore, the rule can specify that no data is to be transmitted on a first carrier before and a second carrier after the N carriers for uplink transmissions, where the carrier before and the carrier after the N carriers for uplink transmissions conform to the second slot format.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A computer-implemented method of operating a base station, the method comprising:
receiving, by a user equipment (UE) configured to operate in a set of M carriers in a frequency range 2 (FR2) from 24.25 GHz to 71.0 GHz, a radio resource control (RRC) message from a base station,
wherein the UE is configured to support a carrier aggregation of N carriers for uplink transmissions to the base station, N being smaller than M,
wherein the RRC message comprises configuration information indicating at least two slot formats,
wherein a first slot format comprises more than 7 uplink symbols in a total of 14 symbols, the first slot format applicable for the N carriers for uplink transmissions,
wherein a second slot format comprises zero uplink symbols in the total of 14 symbols, the second slot format applicable for downlink transmissions; and
performing, by the UE, uplink and downlink transmissions based on the configuration information and a rule,
wherein the rule specifies that no data is expected to be transmitted in a carrier before or after the N carriers for uplink transmissions.

2. The computer-implemented method of claim 1,
wherein M is greater than or equal to twice the value of N.

3. The computer-implemented method of claim 1, wherein the configuration information indicates the second slot format is applicable for (M-N) carriers for downlink transmissions.

4. The computer-implemented method of claim 1,
wherein the configuration information further indicates that the second slot format is applicable for a number of contiguous carriers before or after the N carriers for uplink transmissions; and
wherein the rule specifies that no data is expected to be transmitted in a carrier conforming to the second slot format.

5. The computer-implemented method of claim 1,
wherein the second slot format is applicable for P contiguous carriers before the N carriers for uplink transmissions and for Q contiguous carriers after the N carriers for uplink transmissions,
wherein the sum of P, N, and Q is less than or equal to M; and
wherein the rule specifies that no data is transmitted on a first carrier before and a second carrier after the N carriers for uplink transmissions,
wherein the carrier before and the carrier after the N carriers for uplink transmissions conform to the second slot format.

6. The computer-implemented method of claim 1, wherein the first slot format comprises at least one of: (1) UUUUUUUUUUUUUU; (2) FUUUUUUUUUUUUU; or (3) FFUUUUUUUUUUUU, where F represents a flexible symbol and U represents an uplink symbol.

7. The computer-implemented method of claim 1, wherein the second slot format comprises at least one of: (1) DDDDDDDDDDDDDD, (2) DDDDDDDDDDDDDF, or (3) DDDDDDDDDDDDFF, where F represents a flexible symbol and D represents a downlink symbol.

8. The computer-implemented method of claim 1, wherein N is equal to 4.

9. A base station comprising:
at least one hardware processor; and
at least one non-transitory memory storing instructions, which, when executed by the at least one hardware processor, cause the base station to:
transmit, to a user equipment (UE) configured to operate in a set of M carriers, a radio resource control (RRC) message,
wherein the UE is configured to support a carrier aggregation of N carriers for uplink transmissions to the base station, N being smaller than M,
wherein the RRC message comprises configuration information indicating at least two slot formats comprising a total of K symbols each, a first slot format comprising at least K/2 uplink symbols and applicable for the N carriers for uplink transmissions, and a second slot format comprising zero uplink symbols; and
receive, from the UE, uplink and downlink transmissions based on the configuration information and a rule,
wherein the rule specifies that no data is expected to be transmitted in a carrier before or after the N carriers for uplink transmissions.

10. The base station of claim 9, wherein the carrier before or after the N carriers for uplink transmissions specified by the rule is a carrier that conforms to the second slot format.

11. The base station of claim 9,
wherein the UE is configured to support a carrier aggregation of (M-N) carriers for downlink transmissions to the base station.

12. The base station of claim 9, wherein K is either 12 or 14.

13. The base station of claim 9, wherein N is either 7 or 8.

14. The base station of claim 9, wherein the first slot format comprises at least one of: (1) UUUUUUUUUUUUUU; (2) FUUUUUUUUUUUUU; or (3) FFUUUUUUUUUUUU, where F represents a flexible symbol and U represents an uplink symbol.

15. The base station of claim 9, wherein the second slot format comprises at least one of: (1) DDDDDDDDDDDDDD, (2) DDDDDDDDDDDDDF, or (3) DDDDDDDDDDDDFF, where F represents a flexible symbol and D represents a downlink symbol.

16. At least one non-transitory, computer-readable storage medium comprising instructions recorded thereon, wherein the instructions, when executed by at least one data processor of a system, cause the system to:
transmit, from a base station, a radio resource control (RRC) to a user equipment (UE) configured to operate in a set of M carriers,
wherein the UE is configured to support a carrier aggregation of N carriers for uplink transmissions to the base station, N being smaller than M,
wherein the RRC message comprises configuration information indicating at least two slot formats and a rule,
wherein a first slot format comprises at least K/2 uplink symbols in a total of K symbols, the first slot format applicable for the N carriers for uplink transmissions.
wherein a second slot format comprises zero uplink symbols in a total of K symbols, and
wherein the rule specifies that no data is expected to be received in a carrier before or after the N carriers for uplink transmissions; and
perform uplink and downlink transmissions with the UE based on the configuration information and the rule.

17. The at least one non-transitory, computer-readable storage medium of claim 16, wherein the configuration information indicates the second slot format is applicable for (M-N) carriers for downlink transmissions.

18. The at least one non-transitory, computer-readable storage medium of claim 16,
wherein the UE is configured to support a carrier aggregation of P carriers for downlink transmissions to the base station, the sum of N and P being no greater than M;
wherein the configuration information indicates that the second slot format is applicable for P carriers for downlink transmissions, the P carriers for downlink transmissions being before or after the N carriers for uplink transmissions; and
wherein the rule specifies that no data is expected to be received in a carrier of the P carriers for downlink transmissions.

19. The at least one non-transitory, computer-readable storage medium of claim 18, wherein N is smaller or equal to 4.

20. The at least one non-transitory, computer-readable storage medium of claim 16,
wherein the first slot format comprises at least one of: (1) UUUUUUUUUUUUUU; (2) FUUUUUUUUUUUUU; or (3) FFUUUUUUUUUUUU; and
wherein the second slot format comprises at least one of: (1) DDDDDDDDDDDDDD, (2) DDDDDDDDDDDDDF, or (3) DDDDDDDDDDDDFF,
wherein F represents a flexible symbol, U represents an uplink symbol, and D represents a downlink symbol.
